(19) United States
(12) Patent Application Publication
(10) Pub. No.: US 2004/0226025 A1
(43) Pub. Date: Nov. 11, 2004

(54) Communications processor hardware abstraction layer

(76) Inventors: Denis R. Beaudoin, Rowlett, TX (US); Michael J. Hanrahan, Rockwall, TX (US); Gregory Guyotte, Dallas, TX (US); William S. Egr, McKinney, TX (US)

Correspondence Address: Robert L. Troike, Texas Instruments Incorporated, MS 3999, P.O. Box 655474, Dallas, TX, 75265, US

(21) Appl. No.: 10/434,593

(22) Filed: May 9, 2003

(51) Int. Cl. G06F 9/44

(52) U.S. Cl. 719/321; 717/162

(57) ABSTRACT

A method of providing an operating system independent interface between an operating system (OS) and a communications processor media access control MAC (CPMAC) is provided that includes providing a communications processor Hardware Abstraction Layer (CPHAL) between the OS and a driver with the driver communicating to said CPHAL layer which communicates with the communications hardware processor media access control MAC. The operating system passes information to the CPHAL and the CPHAL at a later time returning the information and wherein said CPHAL passes information to the OS in the same way. The Communications Processor Hardware Abstraction Layer (CPHAL) comprises hooks so that the OS-specific coding is embedded into said CPHAL. The start-up initialization between CPHAL and the OS includes providing a protocol that allows the CPHAL to pass details of its feature set and allows CPHAL to retrieve information from the OS.

### COPYRIGHT NOTICE

A portion of the disclosure of this patent document contains material which is subject to copyright protection. The copyright owner has no objection to the facsimile reproduction by any one of the patent of the patent disclosure, as it appears in the Patent and trademark Office patent files or records, but otherwise reserves all copyright rights whatsoever.

### FIELD OF INVENTION

This invention relates to a software interface for a communications processor and more particularly to a Communications Processor Hardware Abstraction Layer (CPHAL) interface to a Communications Processor Media Access Control (CPMAC). The MAC is the part of the data link that includes the address of the source and destination and the method of getting permission to transmit.

### BACKGROUND OF INVENTION

Currently, there are many operating systems such as MS-DOS, Windows 9x, Windows NT, Workstation, Windows 2000 Professional, Linux/UNIX, Macintosh, VxWorks and OS/2. The operating system portions are vastly different for each of these systems. A driver device is needed for each of these operating systems to work with the communications processor. For example, an embedded systems developer is trying to provide a software solution for DSL-Ethernet router. The developer has to support Operating System (OS) such as Linux and VxWorks for example. Part of the developer's solution will be writing drivers to communicate with Ethernet ports. For example, for Linux the driver will be structured in a certain way, which will be different for VxWorks. The driver will not only perform the OS-specific tasks, mandated by the OS but also all the Ethernet-port register settings, buffer management and so on, required for the communications hardware.

A Hardware Abstraction Layer (HAL) interfaces with the hardware. This protects the applications from directly accessing the hardware and provides better operating system stability. A traditional Hardware Abstraction Layer (HAL) wraps an Application Program Interface (API) around the second task (Ethernet—port register settings, etc.). The OS developer need only tell the API to send some data and the API takes care of setting the correct registers, making sure the data is in the correct place for the hardware, etc. It does not take care of the differences between the different Operating Systems (OS), which usually means either special coding for each OS or addressing another layer that performs translation between the HAL and the specific OS.

Experience has shown that the user spends a great deal of time and money providing the solution to this problem. It has also been determined that the level of performance of the system has been often been hindered by the prior art solutions.

### SUMMARY OF INVENTION

In accordance with one embodiment of the present invention a Communications Processor Hardware Abstraction Layer (CPHAL) provides hooks (OsReceiveInfo and OsSendInfo parameters) so that the OS-specific coding is embedded into an OS-independent HAL API. The CPHAL code does not need to be modified for moving to a different a different OS because of features designed into the API. The OS takes advantage of the hooks present to support the OSs special needs.

In accordance with an embodiment of the present invention an interface to the CPMAC hardware for an operating system and driver that is independent of the operating system. The abstraction layer communicates to the driver and the abstraction layer communicates with the hardware. The abstraction layer knows the registers to set on the CPMAC hardware, receives the operating system protocol information stores it, sets up an independent communication channel that the hardware accepts, sends or receives, and returns information to the operating system with the protocol information it stores.

### DESCRIPTION OF DRAWING

FIG. 1 illustrates the layers according to one embodiment of the present invention.

FIG. 2 illustrates high-level model of CPHAL Partitioning.

FIG. 3 is a sequence diagram summarizes the action performed by the driver, CPHAL and hardware.

FIG. 4 is a sequence diagram that depicts the initialization process.

FIG. 5 is a sequence diagram that summarizes the Open/Close process.

FIG. 6 is a sequence diagram that depicts the process of opening and closing channels.

FIG. 7 illustrates the CPHAL Call Framework..

### DESCRIPTION OF PREFERRED EMBODIMENTS OF THE PRESENT INVENTION

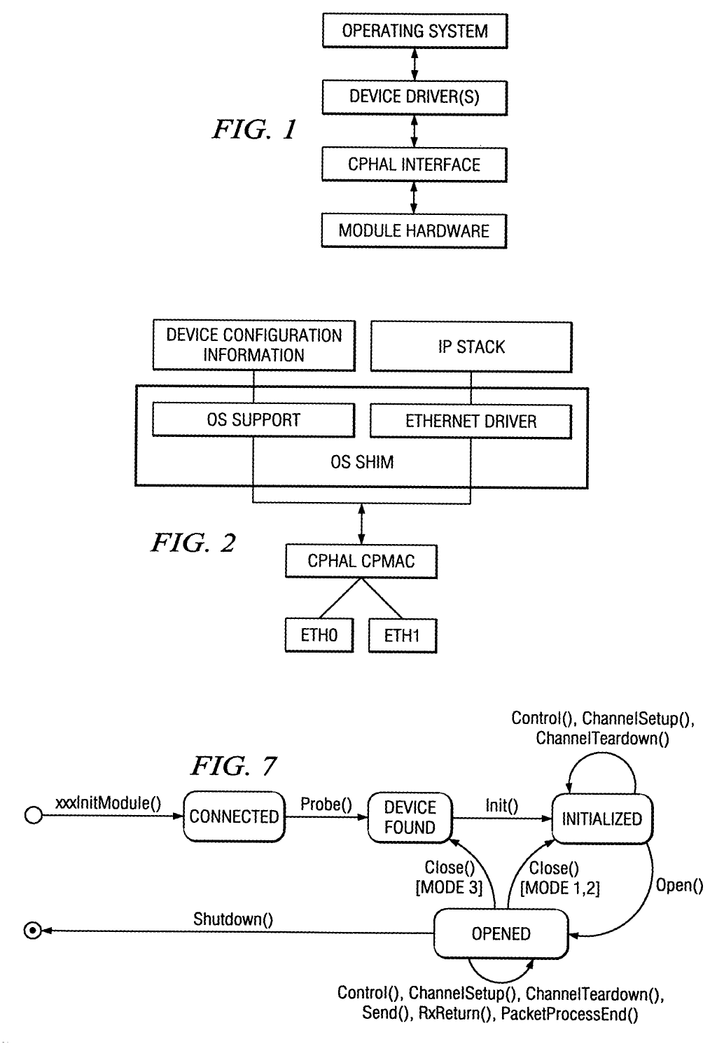

Referring to FIG. 1 there is illustrated a software system diagram showing the role of the Communications Processor Hardware Abstraction Layer (CPHAL). There is on the top layer the operating system (OS). Below the top or operating system layer (OS) is the driver layer. Below the driver layer and between the driver layer and the hardware layer is the CPHAL layer. The OS normally communicates to a communication driver (for example Ethernet) and that talks to the driver. In accordance with the present invention the Ethernet driver communicates to a hardware abstraction layer (CPHAL) and the hardware abstraction layer talks to the hardware. The CPHAL is software that knows the registers, etc. to set the hardware. What it does that is special is that that the OS can pass information to the CPHAL, the CPHAL knows nothing about it, and the CPHAL will at a later time return the information. The CPHAL also can pass information to the OS in the same way. This technique provides an efficient hardware abstraction layer that is OS independent but is designed to take advantage of OS dependencies.

Referring to FIG. 2 there is illustrated a high level model of CPHAL partitioning. The CPHAL CPMAC provides the interface to the CPMAC hardware for the system above. This interface is an OS Shim. The Shim's contents are described in the sections under OS Support and Ethernet driver. The device configuration information is provided to the OS Support and the Ethernet driver is coupled to the IP stack. The CPHAL CPMAC is between the OS Shim and the Ethernet locations.

The process to setup a CPHAL for processing data and setup CPMAC and transfer data are described in the following Table 1.

TABLE 1

| OPERATION | FUNCTION |
|---|---|
| Initialize CPHAL | halCpmacInitModule |
| Find CPMAC port | HalProbe |
| Initialize CPMAC | halInit |
| Open CPMAC | halOpen |
| Setup CPMAC Communication Channel | halChannelSetup |
| Allocate Receive Data Buffer | osMallocRXBuffer |
| Receive Data | osReceive |
| Return Receive Data Buffer to CPHAL | halRxReturn |
| Send Data | halSend |
| Notification of transmit completion | osSendComplete |
| Teardown CPMAC Communication | halChannelTeardown |
| Close CPMAC | halClose |
| Close CPHAL | HalShutdown |

The following will discuss CPHAL initialization, opening and closing the module and configuring channels. Where appropriate, sample code and sequence diagrams are used to illustrate key concepts. The OS Support is in the following Table 2:

TABLE 2

| | OS SUPPORT | |
|---|---|---|
| Operation | Function | Details |
| Memory Allocation | OsMalloc | |
| | OsFree | |
| Configuration Support | DeviceFindInfo | |
| | DeviceFindParmUnit | |
| | DeviceFindParmValue | |
| Stdlib Support | Memset | |
| | Printf | |
| | Sprintf | |
| | Strempi | |
| | Steen | |
| | Strtoul | |

The following Table 3 shows the Ethernet Driver Support:

TABLE 3

| Operation | Function | Details |
|---|---|---|
| Sending Data | HalSend | Send Data |
| | OsSendComplete | Data Sent |
| Receiving Data | OsReceive | Data packet given to OS |
| | OsRxReturn | Os informs CPHAL that id has |
| | | finished with data packet |
| | OsMallocRxBuffer | Os allocates memory for |
| | | Receive data buffer |
| Interrupt | IsrRegister | Registers Module's device level |
| Support | | Interrupt |
| | IsrUnRegister | Unregisters Module's device |
| | | level Interrupt |
| | Hallsr | Os calls CPHAL to process |
| | | packets |
| | halPacketProcessEnd | Os informs CPHAL that |
| | | packet processing is complete. |
| Channel | HalChannelSetup | Sets up a communication |
| Support | | channel |
| | halChannelTeardown | Tears down a communication |
| | | channel |
| CPHAL | halCmpacInitModule | Initializes CPHAL |
| Management | | |
| | HalShutdown | Shutdown CPHAL |
| Module | HalProbe | Probe for Module |
| Support | HallInit | Initialize Module |
| | HalOpen | Open Module |
| | HalClose | Close Module |
| Phy Link | HalTick | |
| Monitoring | | |
| Ioctl Support | HalControl | Allows Setting, Getting and |
| | | Clearing of various CPMAC/ |
| | | CPHAL elements |
| Module Status | Statechange(ioctl) | |

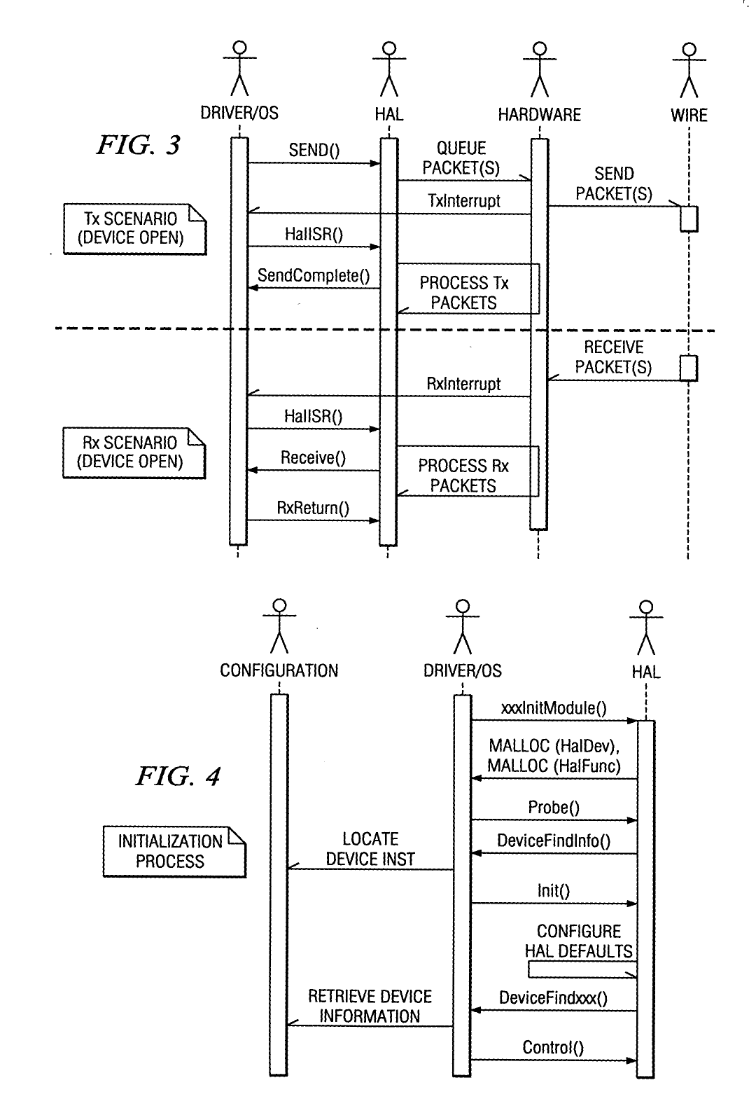

FIG. 3 is a diagram that summarizes the actions performed by the driver, CPHAL, and hardware during both transmit and receive data processing. Each sent packet will result in a call to SendComplete( ) by the CPHAL. Similarly, each received packet will result in a call to Receive( ) by the CPHAL. The CPHAL is completely OS independent, relying on upper layer software to provide basic support functions. Upper layer software programs that interface with CPHAL shall be referred to here as “drivers”. A Linux implementation of the CPMAC Ethernet driver is used for code examples. The Linux upper layer communicates to its drivers via two structures, one a device structure, dev, the other a structure containing the data payload, skb. The device structure contains a driver specific area called priv (private). This area is used by the driver to store specific driver related information. In order to use the CPHAL, the Linux driver must define the following data types: OS_DEVICE (maps to dev), OS_SENDINFO (maps to skb) and OS_RECEIVEINFO (maps to skb). The Linux driver communicates to CPHAL by a CPHAL owned device structure referenced as HalDev. The CPHAL communicates to the driver via the driver's structure, dev (referenced in the API as OS_DEVICE*OsDev). During the start-up handshake between the driver and CPHAL, their respective device structure pointers are saved. The Linux driver saves a copy of the HalDev address in dev→priv and CPHAL saves a copy of the dev address in Hal Dev. In addition the driver and CPHAL reference a pre-defined set of functions via two structure pointers, HalFUNC and OsFunc respectively. FRAGLIST is a structure list containing word pairs consisting of the data packet address and the length of the data packet. In the Linux implementation the number of such pairs is one.

In the sections below, a Linux code snippet that shows how the driver can send data to the communications device, process the transmit complete interrupt, and return the transmit buffer to the upper layer.

```
Driver calls the CPHAL function Send( )
        int LinuxSend (struct sk_buff*skb, struct net_device*dev)
        {
        // Get pointer to the driver priv area.
        VmacPrivateInfo*priv = (VmacPriviteInfo*) dev->priv;
        FRAGLIST fraglist;
        HAL_FUNCTIONS * HalFinc = priv->HalFunc;
        HAL-DEVICE *HalDev=priv->HalDev;
        int rc;
        int retVal=0;
        // Store length of data packet in fraglist packet length area.
        fragList.length = skb->len;
        //Store pointer of data to be transmitted in the fragList address
        area.
        FragList.data = (unsigned char*) virt_to_physical (skb->data);
        /* Send the packet and pass skb pointer to the CPHAL.
              This will be returned by SendComplete( ), */
        Rc = HalFunc->Send (HalDev, &frafList, 1, skb->len, skb,0,0);
        If(rc 1=0)
              {
        // Error occuredin Send( )
        dev_kfree_skb_any (skb);
        priv->ErrorSend++;
        retVal=0;
        }
    return (retVal);
    }
```

Transmit Interrupt

```
static void vmacHandleInterrupt (int irq,void*dev_id,
struct pt_regs * regs)
{
  VmacIsrCBParam * isrCBParam = (VmacIsrParam*) dev_id;
  VmacPrivateInfo * priv=isrCBParam->dev->priv;
HAL-DEVICE *HalDev = priv->HalDev;
// Call the CPHAL ISR, passing the Hal Dev stored in the device
private area.
      isrCBParam-> hallsr (halDev);
} / * vmacHandleInterrupts*/
```

Return the Transmit Buffer

/* CPHAL calls this OS Function and passes back the skb that
the OS passed to CPHAL in the Send( ) call. */
static int SendComplete (OS_SENDIFO * OsSendInfo)
{
// OsSendInfo here is the ‘skb’ the upper layer wanted sending
dev_kfree_skb_any ((struct sk_buff*) Os SendInfo);
return (0);
}

Receive Interrupt

static void vmacHandleInterrupt (int irq, void*dev_id,
struct pt_regs*regs)
{
VmacIsrCBParam * isrCBParam = (VmacisrCBParam*) dev_id;
VmacPrivateInfo * priv = isrCBParam->dev->priv;
Hal_DEVICE *HalDev= priv->HalDev;
/* call the CPHAL ISR function, passing the HalDev stored in the device
private area.*/
isrCBParam->hallsr (HalDev);
}/*vmaccHandleInterrupts*/

CPHAL returns Received Data to Driver

When the CPHAL processes RX data, it fills Rx buffers and passes the buffers to the driver via the Receive( ) interface. The driver, in turn, must return the halReceiveInfo into the CPHAL. Each Receive( ) call should result in a call by the driver to RxReturn( ). static int Receive (HAL_DEVICE HalDev, FRAGLIST fraglist, int FragCount.

int PacketSize, HAL_RECEIVEINFO*halReceive info,
OS_RECEIVEINFO*OSReceiveInfo, int Mode)
// CPHAL returns the ‘skb’ via the OsReceiveInfo parameter,
struct sk_buff=(struct sk_buff*) osReceiveInfo;
struct net_device *dev=skb->dev; // Linux ‘dev’ stored in the
‘skb’
VmacPrivateInfo * priv=(VmacPrivateInfo*) dev->priv;
HAL_FUCTION * HalFUNC+priv->HalFunc;
// For Linux Ethernet driver, do some related processing
dma_cache_inv ((struct sk_buff *) skb->data, PacketSize);
/* set length & tail*/
skb_trim(skb, PacketSize);
netif_rx(skb);
// Call CPHAL to inform the driver has finished with the Receive
//Buffer and has kept it.
HalFunc->RxReturn ( HalDev, HalReceiveInfo,1);

}

Programming Details

Accessing CPHAL Functions and Data Structures

The driver will need to include a header file (cphal.h) which contains all of the necessary shared data structure and function definitions. Establishing Communications with CPHAL.

The CPHAL exposes a single external interface, xxxInitModule( ), which initializes communications between the CPHAL and the driver. Since this interface is directly exposed by the individual CPHAL modules, it has a different name for each module. The actual names and detailed API documentation for the xxxInitModule ( ) functions are documented in the module specific descriptions. Note the driver must allocate OsDev and OsFunc, while the CPHAL allocates HalDev and HalFunc.

// call CPHAL to inform that Driver has finished with the Receive
//Buffer and has kept it.
HalFunc-<RxReturn(halReceiveInfo,1);
Return (0);
)

Module Initialization

FIG. 4 is a sequence diagram that depicts the initialization process. After establishing communications to the CPHAL, the driver must call Probe ( ), which probes the CPHAL for the instance of the desired module. The CPHAL, in turn, uses DeviceFindInto ( ) to locate the device information associated with the current instance of the module. Probe ( ) will return 0 if the call is successful.

Next, the driver will call Init ( ), which performs module initialization. Each CPHAL module is subject to certain default configuration values, which are configured first. Init ( ) then accesses the device configuration parameters via the DeviceFindParmValue ( ) and DeviceFindParmUint ( ) functions. Parameter values discovered in this way will override the CPHAL default values. After Init ( ), the driver may call Control ( ) to override any of the current configuration values. For more information on the available parameters for the CPSAR or CPMAC entries in the device configuration file, please reference Appendix A.

The following code segment illustrates how the CPHAL will extract channel information from the configuration database.

// Obtain Number of Tx Buffers for Channel 0
OsFunc->DeviceFindInfo(HalDev->Inst, “cpmac”, &CpmacInfo);
// Get channel 0 information info
OsFunc->DeviceFindParmValue(CpmacInfo, “ch0”, %Ch0Info);
// Get the number of Tx Buffers using information for Ch0
OsFunc->DeviceFindParmUint(Ch0Info, “NumTxBufs”, &NumTxBufs);

Opening the Closing CPHAL Module

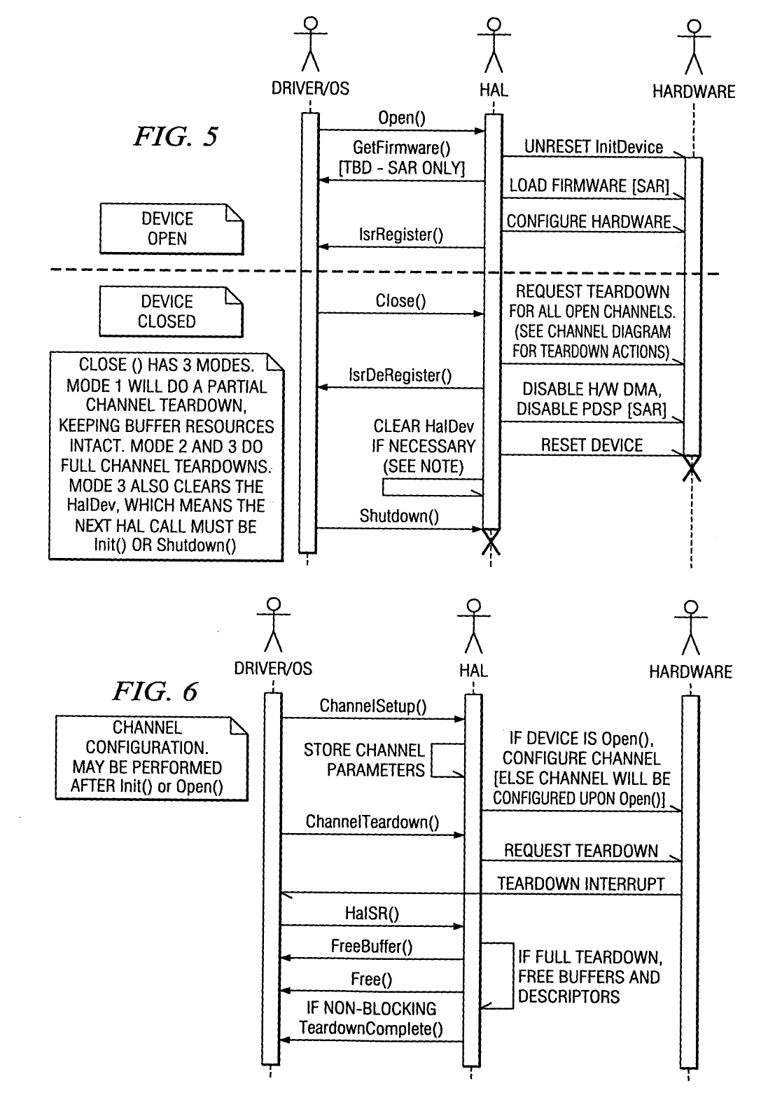

FIG. 5 is a sequence diagram that summarizes the Open/Close process. After the CPHAL initialization process, the driver may call Open ( ) to open the module for operation. The CPHAL will take the device out of reset, initialize the hardware, and call IsrRegister ( ) to register the CPHAL's interrupt processing routine (HalISR ( )). Note that the driver may call HalISR ( ) at any time to process Tx and Rx data, not necessarily in the interrupt context. After Open ( ) has completed, the module is ready for use.

To close a CPHAL module, use the Close ( ) API. The Close ( ) function closes all open channels, with the Mode parameter controlling the option of freeing (FULL teardown) or reusing (PARTIAL teardown) buffer resources. Three different modes of operation may be specified through the Mode parameter.

Mode 1: Calls ChannelTeardown( . . . , PARTIAL) for all open channels.

Mode 2: Calls ChannelTeardown( . . . , FULL) for all open channels.

Mode 3: Calls ChannelTeardown( . . . , FULL) for all open channels. Clear configuration parameter values and channel configuration.

Mode 1 and 2 are intended as an attempt to perform a quick reset of the system. The next call to the CPHAL may be Open ( ), or Control ( ) to modify parameter values. Mode 3 is typically followed by Shutdown ( ) when the system is going offline. Following a Mode 3 Close ( ), the caller must reinitialize the CPHAL (Init( )) before reopening (Open ( )).

During each call to Close ( ), the CPHAL module will use OS function InsrUnRegister ( ) to unregister the interrupt service routine for the module. It will also deactivate the hardware and put the device into a reset state.

After Close ( ) has completed, if the driver no longer wants to use the module, if may call the Shutdown ( ) API. This interface will free the HalDev and HalFunc structures that are maintained by the CPHAL, effectively breading all communication between the OS layer and the CPHAL layer for this module.

Opening and Closing Channels

FIG. 6 is a sequence diagram that depicts the process of opening and closing channels. Channels may be operated at any time following the Init ( ) call. To open a channel, the driver must call ChannelSetup ( ). The API requires the caller to pass values for each member in the CHANNEL.INFO structure. The caller may pass the value 0×FFFFFFFF for any value in the channel structure, which will cause the CPHAL to use a default value for that parameter. Attempting to open a channel that has already been opened will result in an error code being returned. Please reference the appendices for more detailed information on the use of channels for a particular module.

To close a channel, the driver may call ChannelTeardown ( ) at any time. Each individual module may support a different number of channels, so reference the module specific appendix to determine the range of the parameter Ch. The Mode parameter specifies multiple pieces of information: a) it tells the CPHAL what to do with the memory resources associated with the channel, b) it indicates whether the teardown applies to Rx, Tx, or both, and c) it indicates whether the teardown call is blocking or non-blocking. Details of this operation are given in the CPHAL API documentation.

Once the CPHAL has performed all required procedures to teardown the channel, it will call TeardownComplete ( ) (if the ChannelTeardown( ) call was specified as non-blocking). It is up to the driver developer to determine the implementation of TeardownComplete ( ), as no action is explicitly required by the CPHAL.

CPHAL Call Framework Summary

The CPHAL, in abstracting the hardware, imposes a call framework upon the driver. This is necessary due to requirements of the hardware for certain tasks to be done in a given order. A main goal of the framework is to increase the software reliability by enforcing order on hardware configuration. A second goal of the framework is to improve system performance by encapsulating the primary drivers of performance within the CPHAL.

The call framework can be summarized in the conceptual state diagram or FIG. 7. It depicts the overall order of CPHAL function calls. The internal CPHAL states listed below simply illustrate the order enforced upon call flow; the driver software does not need to maintain any concept of state. Certain calls cause state transitions (Probe( ),Init( ), etc . . . ), while other calls are performed within a certain state. Several calls may be performed in multiple states (Control( ), ChannelSetup( ), ChannelTeardown( ), etc . . . ).

Monitoring CPHAL Status

The CPHAL has an interface designed to allow the driver to poll the module at regular intervals to determine the module status. The CPHAL will call the OS function Control ( ) during the initialization process to set an interval value for the “Tick” parameter. The OS may use this value to set up a timer to call Tick ( ).

When Tick ( ) is called, the CPHAL will check the module status. If there are no state changes to report, the CPHAL will do nothing. If there is something to report, the CPHAL will call Control ( ) with a key parameter of “StateChange”. At this time, the O(S may call Control ( ) to “Get” (action) the “Status” (key). The values returned are defined on a module specific basis, and are documented in the corresponding module appendix.

During shutdown, the CPHAL will call Control ( ) again to change the value of the “Tick” parameter to 0, which should be interpreted by the driver as an attempt to disable the timer.

Other OS Support Functions

The CPHAL requires some additional OS support functions to be implemented by the driver in order to operate properly. These functions are defined in the second OS Functions. Please review the OS API carefully and supply an implementation for EVERY function. Note: The driver developer may have to develop a different implementation for each of these functions per supported operating system.

Data Structures

The following data structures are shared by all modules:

struct CHANNEL_INFO

struct FRAGLIST

strut HAL_FUNCTIONS

strut OS_FUNCTIONS.

FRAGLIST Struct Reference has the Data Fields:

Bit32u len

void*data

void*OsInfo

Each fragment list entry contains a length and a data buffer. The field documentation is void*FRAGLIST:: data is a pointer to fragment data, void*FRAGLIST::OsInfo is a pointer to OS defined data and bit32u FRAGLIST:: len is the length of the fragment in bytes (lower 16 bits are valid). For SOP, upper 16 bits is the buffer offset.

CHANNEL_INFO Struct Reference has the Data Fields

Int Channel

Int Direction

Channel specific configuration information. This structure should be populated by upper-layer software prior to calling ChannelSetup ( ). Any configuration item that can be changed on a per channel basis should be represented here. Each module may define this structure with additional mode-specific members. The field documentation is:

int CHANNEL_INFO:: Channel is the channel number.

Int CHANNEL_INFO:: Direction refers to transmit (Tx) or receive (Rx).

HAL_FUNCTIONS Struct Reference Data Fields

int(*ChannelStepip) (HAL_DEVICE*HALdEV, channel_info* Channel<OS_SETUP*OsSetup)

int(*ChannelTeardown) HAL_DEVICE*HalDev, int Channel, int Mode)

int(*Close) (HAL_DEVICE*HalDev, int Mode)

int(*Control) (HAL_DEVICE*HalDev, const char*Key, const char* Action, void*value)

int(*Init)(HAL_DEVICE*HALDev)

int(*Open) (HAL_DEVICE*HalDev)

int(*PacketProcessEnd) (HAL_DEVICE*HalDev)

int(*Probe) (HAL_DEVICE*HalDev)

int*RxReturn)(HAL_RECEIVEINFO*HalReceiveInfo, int StripFlag)

int(*Send) (HAL_DEVICE*HalDev,FRAGLIST*FragList, intFragCount,int PacketSize,OS_SENDINFO*OsSendInfo, bit32uMode)

int(*Shutdown) (HAL_DEVICE*HalDev)

int(*Tick) (HAL_DEVICE*HalDev)

The HAL_FUNCTIONS struct defines the function pointers used by upper layer software. The upper layer software receives these pointers through the call to xxxInitModule( ).

OS_FUNCTIONS Struct Reference Data Fields

int(*Control) (OS_DEVICE*OsDEV,const char*Key, const char*Action,void*Value

void(*CriticalOn)(void)

void(CriticalOff)(void)

void(*DataCacheHitInvalidate)(void*MemPtr,int Size)

void*DataCacheHitWriteback)(void*MemPtr,int Size)

int(*DeviceFindInfo) intInst,const char*DeviceName,void*DeviceInfo)

int(*DeviceFindParmUnit) (void*DeviceInfo, const char*Parm,bit32u*Value)

int(*DeviceFindParmValue) (void*DeviceInfo, const char Parm,void *Value)

void(*Free)(void*MemPtr)

void(*FreeRxBuffer)(OS_RECEIVEINFO*OsReceiveInfo,void*MemPtr)

void(FreeDev) (void*memPtr)

void(FreeDmaXfer)(void*MemPtr)

void(*IsrRegister)(OS_DEVICE*OsDev, int(*HalISR) HAL_DEVICE*,int*,int InterruptBit)

void(*IsrUnRegister) (OS_DEVICE*OsDev, intInterruptBit)

void*(*Malloc) (bit32u size)

void*(*MallocDev)(bit32uSize)

void*(*MallocDmaXfer) (bit32u size,void,*MemBase,bit32u MemRange)

void*(*MalocRxBuffer) (bit32u size, void*MemBase, bit32u MemRange, OS_SETUP*OsSetup, HAL_RECEIVINGINFO*HalReceiveInfo, OS_RECEIVEINFO OsReceiveInfo, OS_DEVICE OsDev)

void*(*MemSet) (void*Dest,int C, bit,bit32uN)

int(*Printf)(const char*Format . . . )

int(*Receive)(OS_DEVICE*OsDev,FRAGLIST*FragList,bit32u FragCount, bit32u PacketSize, HAL_RECEIVEINFO*HalReceiveInfo, bit32u Mode)

int(*SendComplete) (OD_SNDUNFO*Os SendInfo)

int(*Sprintf)(char*S,const char*Format, . . . )

int(*Strempi)(Const char*Str1, const char*Str2)

unsigned int (*Strlen)(const char*S)

char*(*Strstr)(const char*S1,const char*S2)

unsigned long (*Strtoul)(const char*Str,char**Endptr,int Base)

void(*TeardownComplete) (OS_DEVICE*Os Dev, int Ch, int Direction)

The OS_FUNCTIONS struct denies the function pointers for all upper layer functions accessible to CPHAL. The upper layer software is responsible for providing the correct OS-specific implementations for the following functions. It is populated by calling InitModule( ) (done by the CPHAL in xxxInitModule( ).

CPHAL Functions

int Close (HAL_DEVICE*HalDev, bit 32Mode). This function closes the CPHAL module. It is capable of freeing all allocated memory if the Mode parameter is specified as “Full”.

Parameters:

HalDev CPHAL module instance (set by ephallInitModule( )).

Mode Indicates actions to take on close. PARTIAL-Disable device FULL_Disable device and release all resources.

int halChannelSetup (HAL_DEVICE*Hal Dev,

CHANNEL_INFO*HalCh,OS_SETUP*OsSetup)

This function opens the specified channel. The caller must populate the HalCh structure. CPHAL default values may be requested for any or all members of the HalCh structure by supplying a value of 0×FFFFFFFF for the given member. The OsSetup parameter is a pointer to an OS defined data structure. If the CPHAL later calls MallocRxBuffer( ) this pointer is returned in that call.

Parameters:

HalDev CPHal Module instance. (set by xxxInitModule( )).

HalCh Per channelinformation structure. Implementation specific.

OsSetup Pointer to an OS-defined data structure.

int halChannelTeardown (HAL_DEVICE*HalDev, int Ch, bit32 Mode)

This function performs a teardown for the given channel. The value of the Mode parameter controls the operation of the function, as documented below.

Parameters:

HalDev CPHAL module instance. (set by xxxInitModule( )).

Ch Channel number

Mode Bit 0 (LSB): Perform TX teardown (if set). Bit 1: Perform Rx teardown (if set). Bit 2: If set, perform full teardown (free buffers/descriptors). If clear, perform partial teardown (keep buffers). Bit 3: If set, call is blocking. If clear, call is non-blocking.

int halClose (HAL_DEVICE*HalDev, bit 32Mode)

This function closes the CPHAL module. The module will be reset. The Mode parameter should be used to determine the actions taken by Close( ).

Parameters: HalDev CPHAL module instance. (set by xxxInitModule( )).

Mode Indicates actions to take on close. The following integer values are valid: 1: Does not free buffer resources, init parameters remain intact. User can then call Open( ) without calling Init( ) to attempt to reset the device and bring it back to the last known state. 2: Frees the buffer resources, but keeps init parameters. This option is more aggressive means of attempting a device reset. 3: Frees the buffer resources, and clears al init parameters.

At this point, the caller would have to call to completely reinitialize the device (init) before being able to call Open( ). Use this mode if you are shutting down the module and do not plan to restart.

int halControl (HAL_DEVICE*Hal Dev, const char*key, const char*Action, void*Value)

Performs a variety of control functions on the CPHAL module. It is used to modify/read configuration parameters and to initiate internal functions. The Key indicates the function to perform or the parameter to access ( note that the Keys are identical to those used in accessing the configuration data store). Action is applicable to parameters only, and indicates what the CPHAL should do with the parameter (i.e. “Set”, “Get”, etc.). The actions for each parameter are defined in the module specific documentation.

Parameters:

HalDev CPHAL module instance. (set by xxxInitModule( )).

Key specifying the parameters to change or internal function to initiate. See module specific documentation for available keys.

Action Specifies the action to take.

Value Pointer to new value for given Key parameter (“Set”), or returned value of KEY (“Get”).

Int halInit (HAL_DEVICE*HalDev)

This function initializes the CPHAL module. It gathers all necessary global configuration info from the configuration file and performs initialization and configuration of the device. Note that the device operation is not started until the OS calls Open( ).

Parameters:

HalDev CPHAL module instance (set by xxxInitModule( )).

Int halOpen (HAL_DEVICE*HalDev)

This function starts the operation of the CPHAL device. It takes the device out of reset, and calls IsrRegister ( ). This function should be called after calling the Init( ) function.

Parameters:

HalDev Cphal module instance. (set by xxxInitModule( )).

int halPacketProcessEnd (HAL_DEVICE*HalDev)

Called to retrigger the interrupt mechanism after packets have been processed. Call this function when the HallSR function indicates that there is no more work to do. Proper use of this function will guarantee that interrupts are never missed.

Parameters:

HalDev CPHAL module instance. (set by xxxInitModule( )).

int HalProbe (HAL_DEVICE*HalDev)

This function probes for the instance of the CPHAL module. It will call the OS function DeviceFindInfo( ) to get the information required.

Parameters:

HalDev CPHAL module instance. (set by xxxInitModule( )).

Int halRxReturn (HAL_RECEIVEINFO*HalReceiveInfo, int StripFlag)

This function is called to indicate to the CPHAL that the upper layer software has finished processing the receive data (given to it by osReceive( )). The PHAL will then return the appropriate receive buffers and buffer descriptors to the available pool.

Parameters:

HalReceiveInfo Start of receive buffer descriptor chain returned to CPHAL.

StripFlag Flag indicating whether the upper layer software has retained ownership of the receive data buffers. “True” indicates the data buffers were retained, “False” means that the CPHAL can reuse the receive data buffers. Note: If the StripFlag is True, it is the responsibility of the upper layer software to free the buffers when they are no longer needed.

Int halSend (HAL_DEVICE*HalDev, FRAGLIST*FragList, int FragControl, intPacketSize,OS_SENDINFO*OsSendInfo, bit 32 Mode)

This function transmit the data in the FragList using available transmit buffer descriptors. More information on the use of the mode parameter is available in the mode-specific appendices.

Parameters:

HalDev CPHAL module instance. (set by ephallInitModule( )).

FragList Fragment List structure.

FragCount Number of fragments in FragList.

PacketSize Number of bytes to transmit.

OsSendInfo OS Send information structure.

Mode 32-bit value with the following bit fields: 31-16 Mode: (used for module specific data). 15-08: Queue (transmit queue to send on). 07-00: Channel (channel number to send on).

int halShutdown (HAL_DEVICE*HalDev)

This function shuts down the CPHAL module completely. The caller must call Close( ) to put the device in reset prior to shutting down. This call will free the HalDev and the HAL function pointer structure, effectively ending communications between the driver and the CPHAL. Further use of the module must be initiated by a call to xxxInitModule( ), which starts the entire process over again. Parameters: HalDev CPHAL module instance. (set by xxxInitModule( )).

int halTick (HAL_DEVICE*HalDev)

Used to perform regular checks on the device. This function should be called at a regular interval specified by the Tick parameter.

Parameters: HalDev CPHAL module instance. (set by xxxInitModule( )).

int Open (HAL_DEVICE*HalDev)

This function starts the operation of the CPHAL device. This function is called after calling the CPHAL Init( ) function.

Parameters: HalDev CPHAL module instance. (set by cphallInitModule( )).

int xxxInitModule (HAL_DEVICE**HalDev, OS_DEVICE*OsDev, HAL_FUNCTIONS**HalFunc, OS_FUNCTIONS*Osfunc, int OsFuncSize, int*HalFuncSIZE, intInst)

This function will:

1. allocate a HalDev that will be used by the OS for future communications with the device.

2. save OsDev for use when calling OS functions.

3. allocate and populate HalFunc with the addresses of CPHAL functions.

4. check OsFuncSize to see if it meets the minimum requirement.

5. return the size of the HAL_FUNCTIONS structure through the HalFuncSize pointer. The OS should check this value to ensure that the HAL meets its minimum requirement.

Version checking between the OS and the CPHAL is done using the OsFUNCSIZE and HalFuncSize. Future versions of the CPHAL may add new functions to either HAL_FUNCTIONS or OS_FUNCTIONS, but will never remove functionality. This enables both the HAL and OS to check the size of the function structure to ensure that the current OS and CPHAL are compatible.

Parameters:

HalDev Pointer to pointer to CPHAL module information. This will be used by the OS when communicating to this module via CPHAL. Allocated during the call.

OsDev Pointer to OS device information. This will be saved by the CPHAL and returned to the OS when required.

HalFunc Pointer to pointer to structure containing function pointers for all CPHAL interfaces. Must be allocated by OS prior to call.

OsFuncSize Size of OS_FUNCTIONS structure.

HalFUNCSIZE Pointer to the size of the HAL_FUNCTIONS structures.

Inst The instance number of the module to initialize. (start at 0).

OS Interface API Reference

The CPHAL requires certain resources (in the form of function calls) to be supplied by the OS. Therefore, the user of this API is required to implement a pre-defined set of OS-specific functions whose API is described below in this section. The OS_FUNCTIONS structure defines the required interfaces that the driver must provide implementations for. For example, the CPHAL uses an Malloc( ) call to allocate memory, supplied by the user. Since these implementations are OS-specific, a separate implementation will be required for each desired OS.

Function Documentation

int Control (OS_DEVICE*OsDev, const char*Key, const char*Action, void*Value)

Performs a variety of control functions on the OS. It is primarily used to access/modify configuration information and to initiate internal OS functions. The Key indicates the function to perform or the information to access. Action indicates what the OS should do with Key (i.e. “Set”, “Get”, etc.). The valid actions for each parameter are defined in the module specific documentation.

Parameters:

OsDev OS device structure.

Key—Key specifying the parameter to change or internal function to initiate. See module specific documentation for available keys.

Action—Specifies the action to take.

Value—Pointer to new value for given Key parameter (“Set”), or returned value of Key (“Get”).

void CriticalOFF (void)

CPHAL calls this function when leaving critical sections of code.

void DataCacheHitInvalidate (void*MemPtr,int Size)

Invalidates the cache for the given memory location.

Parameters:

MemPtr—Void pointer to memory.

Size—Number of bytes to invalidate.

void DataCacheHitWriteback (void*MemPtr, int Size)

Writes back to memory the cache contents for the given address.

Parameters:

MemPtr—Void pointer to memory

Size—Number of bytes to write back.

int DeviceFindInfo (int Inst, const char*DeviceName,void*DeviceInfo)

This function is called by the CPHAL to obtain basic module information. The DeviceInfo pointer can be used in a subsequent call to DeviceFindParmXXX( ) to obtain specific parameter values. The pointer will be the “inst'th” instance of the DeviceName found in the configuration database.

Parameters:

Inst—Instance number of DeviceName (starts at 1).

DeviceName—The name of the device to query. Note: DeviceName is case insensitive.

DeviceInfo—Output pointer to device parameter information. CPHAL is responsible for freeing this memory (it must be allocated by the OS).

int DeviceFindParmUint (void*DeviceInfo, const char*Parm, bit32u* Value)

Searches device information specified by DeviceInfo for the parameter specified by Parm. It then checks the syntax of the 32-bit unsigned value associated with Parm and returns it in Value if it is a valid value.

Parameters:

DeviceInfo—Pointer to device information (returned by DeviceFindInfo( ))

Parm—Parameter to get. Note: Parm is case-insensitive.

Value—Returned value of Parm.

int DeviceFindParmValue (void*DeviceInfo, const char*Parm, void*Value)

Searches device information specified by DeviceInfo for the parameter specified by Parm. It then returns the value associated with the Parm through the Value parameter.

Parameters:

DeviceInfo—Pointer to device information. (returned by DeviceFindInfo( ))

Parm—Parameter to get. Note: Parm is case-insensitive.

Value—Pointer to value. CPHAL is responsible for freeing this memory.

void Free (void*MemPtr)

This function is used by the CPHAL to free memory.

Parameters:

MemPtr—Pointer to memory block to free.

void FreeDev (void*MemPtr)

Frees the specified device structure.

Parameters:

MemPtr—Pointer to memory.

void FreeDmaXFer (void*MemPtr)

Frees memory.

Parameters:

MemPtr—Pointer to memory.

void FreeRxBuffer (OS_RECEIVEINFO*OsReceiveInfo, void* MemPtr)

Frees the specified data buffer.

Parameters:

OsReceiveInfo—Pointer to OS info.

MemPtr—Pointer to memory.

void IsrRegister (OS_DEVICE*OsDev, int(*HalISR)(HAL_DEVICE*,int*),Int Interrupt)

This function is called by the CPHAL to enable the OS to register the ISR to the supplied interrupt and HalDev.

Parameters:

OsDev—OS device structure.

HalISR—Pointer to the ISR function in the CPHAL to be mapped to Interrupt.

Interrupt—Number of the interrupt to be associated with HalISR.

void IsrUNRegister (OS_DEVICE*OsDev, int Interrupt)

This function is called by the CPHAL to remove the ISR mapping for a given Interrupt number.

Parameters:

OsDev—OS device structure.

Interrupt—Number of the Interrupt to be associated with HalISR.

void*Malloc (bit32u Size)

Allocates memory. It returns a void pointer to the allocated memory, which the caller may typecast to the desired data type.

Parameters:

Size is size of memory block to allocate.

Returns: void pointer to allocated memory.

void*MallocDev (bit32u Size)

Allocates memory for the CPHAL's device structure.

Parameters: Size—Size of memory block to allocate.

Returns: Void pointer to allocated memory.

void*MallocDmaXfer (bit32u Size, void*MemBase, bit32u MemRange)

Allocates memory in a DMA-able memory range. The DMA memory range is passed in this function using the MemBase and MemRange parameters.

Parameters:

Size is size of memory block to allocate.

MemBase—Base address of DMA-able memory range.

MemRange—Size of DMA-able memory range.

void*MallocRxBuffer (bit32u Size, void*MemBase, bit 32u MemRange, OS_SETUP OsSetup, HAL_RECEIVEINFO*HalReceInfo, OS_RECEIVEINFO**OsReceiveInfo, OS_Device*OsDev)

Mallocs memory for the CPHAL's data buffers. The buffers are required to be allocated within the DMA-able memory area, which is passed in this function through the Mem-Base and MemRange parameters. Through OsReceiveInfo, the OS can supply information that will be given back to the OS through the call to Receive( ).

Parameters:

Size—Size of memory block to allocate.

MemBase—Base address of DMA-able memory range.

MemRange—Size of DMA-able memory range.

OsSetup—Pointer to OS info (from ChannelSetup( ) returned to the caller here.

HalReceiveInfo—Private CPHAL information.

OsReceiveInfo—Pointer to OS info to be returned by Receive( ).

OsDev—OS_DEVICE pointer.

void*Memset (void*Dest, int C, bit 32uN)

Refer to any standard C run-time library reference for a complete function description.

This function sets the first N bytes of Dest to the value C.

Parameters:

Dest—Pointer to destination.

C—Character value memory will be sent to.

N—Number of characters to set.

int Printf (const char*Format, . . . )

Refer to any standard C run-time library reference for a complete function description.

Parameters:

Format is format control string.

int Receive (OS_DEVICE*)OsDev,FRAGLIST*FragList, bit32u FragCount,bit 32u PacketSize, HAL_RECEIVEINFO*HalReceiveInfo, bit32u Mode)

This function is called by the CPHAL to pass received data to the OS layer. The data is passed as an array of FRAGLIST structures, with each element containing a length and a buffer pointer. The number of elements, or fragments, is given as FragCount. The entire packet size in bytes is given in the PacketSize parameter. The CPHAL passes a pointer to a private data structure (halReceiveInfo) that must be returned to CPHAL via the RxReturn( ) interface, once the driver has completed receive processing. The OsInfo (specified in MallocRxBuffer( )) is passed back to OS here in the FRAGLIST structure.

Parameters:

OsDev—OS device structure.

FragList—Array of FRAGLIST structure consisting of three 32-bit words containing Length, Data Address, and OsInfo

FragCount—Number of Length and DataAddress pairs in FragList

PacketSize—Number of bytes received

HalReceiveInfo—Pointer to CPHAL information used to be returned to the CPHAL via RxReturn( ).

Mode is Implementation specific.

int SendComplete (OS.SENDINFO*OsSendInfo)

Indication to OS that transmission has completed.

Parameters:

OsSendInfo—Pointer to OS-specific information. This structure was passed to the CPHAL via Send( ), and returned to the OS here.

int Sprintf (char*S, const char*Format, . . . )

Refer to any standard C run-time library reference for a complete function description.

Parameters:

S—Null-terminated output string.

Format is format control string.

int Strempi (const char*StrI, const char*Str2) [static]

Case-insensitive string comparison. Refer to any standard C run-time library reference for a complete function description.

Parameters:

Str1—First string for comparison.

Str2—Second string for comparison.

unsigned int Strlen (const char*S) [static]

Returns the length of the given string. Refer to any standard C run-time library reference for a complete function description.

Parameters:

S—Input string.

char*Strstr (const char*S1, const char*S2) [static]

Locates the first occurrence of the string S2 in string S1. Returns a pointer to the located string, or a null pointer if the string is not found. Refer to any standard C run-time library reference for a complete function description.

Parameters:

S1—String that is to be searched.

S2—Pattern to search for in S1.

unsigned long*Strtoul (const char*Str,char**Endptr,int Base) [static]

Converts the initial portion of the string pointed to by Sytr to a type unsignedlong integer representation. Refer to any standard C run-time library reference for a complete function description.

Parameters:

Str—Input string.

Endptr—Pointer to first unread character.

Base—Number base (0 or 10 for decimal, 16 for hex).

void TeardownComplete (OS.DEVICE*OsDev,int Ch,int Direction)

This function is called by the CPHAL to indicate a channel teardown request has completed. Any necessary teardown related tasks can be performed by the driver here.

Parameters:

OsDev—OS device structure.

Ch—Channel number.

Direction—Indicates which side of the channel was torndown. Bit 0, Tx is torndown (if set). Bit 1, Rx is torndown (if set).

### Appendix A

Configuration and Control

Configuration information resides in a repository of configuration information names in the BSP Configuration Module. The CPHAL and other software modules access this configuration information using a common API, which is documented here as part of the OS Functions. Refer to the documentation for DeviceFindInfo( ), Device-FindParmValue( ), and DeviceFinfParmUint( ).

Data stored in the BSP Configuration Module is arranged on a device by device basis. The DeviceFindParmInfo( ) interface is used to access the information pertaining to a given device. The DeviceFindParmValue( ) and DeviceFindParmUint( ) interfaces are used to extract string or integer data, respectively. Data is accessed by providing a pre-defined Key string, which corresponds to a configuration Value.

Some data, such as channel information, is stored in a hierarchical fashion. When accessing channel information, the CPHAL must call DeviceFindParmValue( ) or DeviceFindParmUnit( ) to extract channel information based upon the channel reference.

The configuration parameters for each CPHAL module are modifiable and readable using the Control( ) interface. The caller must pass a string to identify the parameter to modify in the Key (ex. To modify Debug parameter, pass “Debug”). The caller must also pass a string indicating the action to take through the Action field (ex. “Set”, “Get”).

Variables

Const char pszBase[ ]=“base” [static]

Base address for the module

Const char pszCpuFreq[ ]=“CpuFreq”

CPU Frequency

Const char pszDebug[ ] “Debug” [static]

This is the debug level . The field is defined such that the user should set to 1 all the bits corresponding to desired debug outputs.

CPHAL exposing aconst char pszIntLine[ ]=“int_line [static]

Interrupt line for the odule

Constr char pszOffset[ ]=“offset” [static]

VLYNQ offset for the module. Disregard if not use VLYNQ

Const char pszResetBase[ ]=“ResetBase” [static]

Reet base address for the module.

Const char pszResetBit[ ]=“reset_bit”

Reset bit for the module.

The following documents the keys used with the OS Control ( ) interface that are required by CPHAL devices.

Const char pszSioFlush[ ]=“SioFlush” [static]

Requsts the OS to flush it's 10 buffers. No actions are defined.

Const char pszSleep[ ]=“Sleep”

Used to wait for an integer number of clock ticks, given as an integer pointer in the Value parameter.

A packet interface is provided such that all of the device protocols have to write to this register. The interface to and from the OS is OS generic that when binding with the OS Shim works. It provides a solid boundary that is above the hardware that actually hides and manages all effective hardware caching and algorithms. The HAL keeps track of the information that is given by the OS and return it when it is done. It is not managed. It is a pointer to a block of information. The CPHAL does not look into it and does not use it. It keeps track of it and when done with transmitting and receiving gives it back.

1. A method of providing an operating system independent interface between an operating system (OS) and a communications processor media access control MAC (CPMAC) comprising the steps of:
providing a communications processor Hardware Abstraction Layer (CPHAL) between the OS and a driver;
said driver communicating to said CPHAL layer which communicates with the communications hardware processor media access control MAC; and
said operating system passing information to the CPHAL and the CPHAL at a later time returning the information.

2. The method of claim 1 wherein said Communications Processor Hardware Abstraction Layer (CPHAL) comprises hooks so that the OS-specific coding is embedded into said CPHAL.

3. The method of claim 1 wherein said CPHAL knows all registers to set on the CPMAC.

4. The method of claim 1 wherein said CPHAL passes information to the OS in the same way.

5. The method of claim 1 wherein at start-up initialization between CPHAL and the OS includes providing a protocol that allows the CPHAL to pass details of its feature set and allows CPHAL to retrieve information from the OS.

6. A method to setup communications processor media access control MAC (CPMAC) and transfer comprises the steps of:
establishing communication to the Communications Processor Hardware Abstraction Layer (CPHAL) by the driver by probing the CPHAL for an instance of a desired module;
performing module initialization of said desired module;
finding CPMAC port;
initializing CPMAC;
opening CPMAC;
setting up CPMAC communication channel;
allocating receive data buffer;
receiving data;
returning receive data buffer to CPHAL; and
sending data;

7. The method of claim 6 including the steps of notifying transmit completion;
tearing down CPMAC communication channel;
closing CPMAC; and
closing CPHAL.

8. A method of providing a communications interface to a communications processor for an operating system (OS) and driver comprising the steps of
determining registers to set up on the communications processor;
receiving OS protocol information;
setting up independent communications channel that the communicatins processor accepts, sends or receives; and
returning information to the operating system (OS) with the protocol information it stores.
